(19) United States
(12) Patent Application Publication
(10) Pub. No.: US 2010/0114391 A1
(43) Pub. Date: May 6, 2010

(54) SYSTEM FOR ACQUISITION OF DATA AND MULTIPLICATION OF SIGNALLING AND PROTECTION CONTACTS IN EQUIPMENTS OF SUBSTATIONS AND ELECTRIC POWER PLANTS AND SIMILAR

(76) Inventor: Eduardo Pedrosa Santos, Atibaia/SP- (BR)

Correspondence Address: MCKEE, VOORHEES & SEASE, P.L.C., 801 GRAND AVENUE, SUITE 3200, DES MOINES, IA, 50309-2721, US

(21) Appl. No.: 12/531,617

(22) PCT Filed: Mar. 3, 2008
(86) PCT No.: PCT/BR08/00055

§ 371 Date: Sep. 16, 2009

(30) Foreign Application Priority Data
Mar. 20, 2007 (BR) PI 0700838-4

(51) Int. Cl. G06F 1/28; H04L 9/00

(52) U.S. Cl. 700/292; 380/255

(57) ABSTRACT

System for acquisition of data and multiplication of signalling and protection contacts in equipments of substations and electric power plants and similar, it consists in the utilization of auxiliary relays (4) for contacts multiplication (2) of devices (1) of protection and supervision as a way of entrance of the information for digital acquisition of data, also making possible that the digital acquisition of the state of the contacts (2) of the protection and supervision devices is accomplished directly in the devices properly said by means of the incorporation of simple circuits at the same.

### BRIEF INTRODUCTION

This request of Patent of Invention refers to a new “SYSTEM FOR ACQUISITION OF DATA AND MULTIPLICATION OF SIGNALLING AND PROTECTION CONTACTS IN EQUIPMENTS OF SUBSTATIONS AND ELECTRIC POWER PLANTS AND SIMILAR”, notedly of a system that uses auxiliary relays for multiplication of contacts of protection and supervision devices as entrance of the information for digital acquisition of data, also making possible that the digital acquisition of the state of the contacts of the protection and supervision devices are accomplished directly in the devices by means of the incorporation of simple circuits at the same, reducing the number of necessary discreet entrances in the data acquisition system, reducing the number of discreet entrances needed in the system of data acquisition, reducing and simplifying the connection form of the spinning besides reducing the necessary number of exit contacts in the auxiliary relays. In consequence, it is possible to reduce the costs and time of project, installation, tests and maintenance of the referred systems.

### BRIEF HISTORY

In plants of generation and substations of transmission and distribution of electric power is used a great quantity of high tension equipments, including generators, power transformers, circuit breakers, sectional keys of high tension, among countless other equipments.

All the equipments possible of utilization in the locations above-mentioned have several auxiliary systems for supervision of its operation condition, protection against internal and external defects and also on-line monitoring systems of your state for maintenance.

Several auxiliary systems for supervision, protection and monitoring have in common the use of a great number of sensors and devices that has exit contacts that are activated to make signallings, indicate alarms or to provoke the emergency disconnection of the equipment. Thus, these systems have an enormous quantity of exit contacts.

### STATE OF TECHNIQUE

In equipments used in substations there is the frequent need to activation information of a same contact being of big importance in different systems of installation, what force the utilization of sensors and devices with several repeated exit contacts to a same function, or the utilization of auxiliary relays for multiplication of contacts. The exit contact of the sensor or device is connected to the bobbin of the auxiliary relay, bobbin that activates several exit contacts of the relay, and each one of these contacts transmits the information to a different system.

When the contact that is being multiplied is a contact for emergency disconnection of the equipment, such auxiliary relay should be of fast performance, so that not insert a substantial delay between energizing of your bobbin and the performance of the exit contacts. Thus it is avoided a retard in the transmission of the disconnection signal that could worsen the damages caused by a defect.

Following the tendency above described, some of the systems that should receive the information of the referred contacts are the supervision systems of substation/plant and of monitoring of the high tension equipments. In general, such systems obtain this information by connection of one of the exit contacts of the auxiliary relays to digital data acquisition equipment that has an independent entrance for each contact that is wished monitor. With that, it is observed that, as it increases the quantity of contacts to be monitored, also increases the number of necessary entrances in the data acquisition equipments, as well as it increases the necessary spinning to interlink the exit contacts of the auxiliary relays to the acquisition equipment. This gets worse with the fact of the acquisition equipment is generally located in the control room of the substation, distant dozens or hundreds of meters of the auxiliary relays, located generally in the patio of the substation.

On the other side, as increases the quantity of systems that should receive the information of the contacts, also increases the quantity of exit contacts necessary in the auxiliary relays.

The data acquisition equipment has one or more exits that generally consist on serial communication doors for transfer of the data related to supervision or monitoring systems of the equipment.

The conventional system of protection, supervision and monitoring of high tension equipment, presents, therefore, the following inconvenients:
as increases the quantity of contacts to be monitored, it increases of directly proportional form the number of necessary entrances in the data acquisition equipment, increased the number of susceptible points of failures, being them more wasteful and occupying more spaces in the control panels;
as increases the quantity of contacts to be monitored, also it increases the quantity of necessary spinning to interlink the exit contacts of the auxiliary relays to the acquisition equipment. This, associate to the fact of the equipment of generally distant acquisition of the auxiliary relays were located, transforms the implantation of these systems more wasteful to when multiplying the quantity of necessary spinning, increases the space required in the installation of cables, besides increasing the number of potential points of failure;
as increases the quantity of systems that should receive the contact information, also increases the quantity of necessary exit contacts in the auxiliary relays, transforming them more wasteful, increasing their dimensions, what it carries them occupy more space in the control panels, besides increasing the number of potential points of failure.

### OF NEW INVENTION

It is a system that integrates the functions of the fast auxiliary relays for device contacts multiplication of protection and supervision, as entrance of the information for digital acquisition of data, also making possible that the digital acquisition of the state of the contacts of the protection and supervision devices are accomplished directly in the devices by means of the incorporation of simple circuits at the same, independent of a little used physical, so that the state information of the contacts before transmitted of discreet form with a thread for each contact, now is transmitted of digital form, so that the a little physical need not to be enlarged as it increases the quantity of contacts to be monitored.

### OF ADVANTAGES OF INVENTION

Utilization of only an entrance in the data acquisition equipment to monitor the state of a great number of contacts. Thus, equipments become less wasteful as reduces the quantity of contacts to be monitored, besides reducing the space occupation in the control panels and consequently reducing the number of susceptible points of failure;
as increases the quantity of contacts to be monitored, it is enough connect in parallel the exits of acquisition of the auxiliary relays or protection and additional supervision devices that cause little increase in the quantity of necessary spinning, since the auxiliary relays or protection and supervision devices are nearby each other;
The remote transmission of the acquired information is made by a communication channel that does not need expansions as increases the quantity of contacts to be monitored. It can be used physical means of low cost communication, as, for instance, a pair-braided, besides several other options as optic fiber, wireless communication, and others;
It reduces the number of necessary exit contacts in the auxiliary relays multipliers of contacts, because it is not necessary to use an exit contact of each relay for the data digital acquisition equipment. With that, it reduces the cost and the dimensions of these relays, avoiding the occupation of additional space in the control panels.

### DETAILED DESCRIPTION

To follow, the invention will be explained technically, using as base the drawings below:

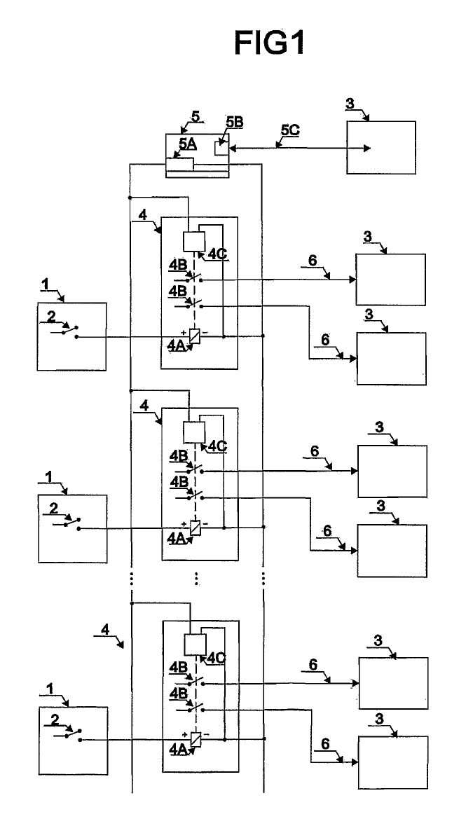

FIG. 1: Schematic of the system for acquisition of data and multiplication of signalling and protection contacts in equipments of substations and electric power plants and similar, showing the basic components as the sensor or device, auxiliary relay, and exit contacts interlinked to any system;

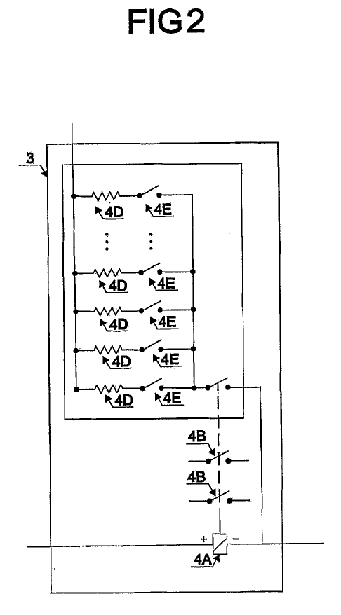

FIG. 2: Schematic of the system for acquisition of data and multiplication of signalling and protection contacts in equipments of substations and electric power plants and similar, showing technology in which the transmission of the information occurs in the form of analogical signal;

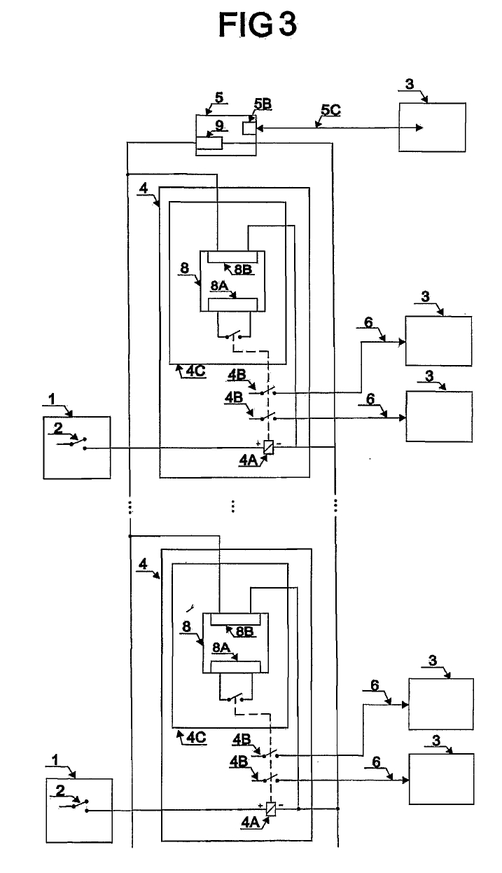

FIG. 3: Schematic of the system for acquisition of data and multiplication of signalling and protection contacts in equipments of substations and electric power plants and similar, showing technology in which the transmission of the information occurs through an electronic circuit;

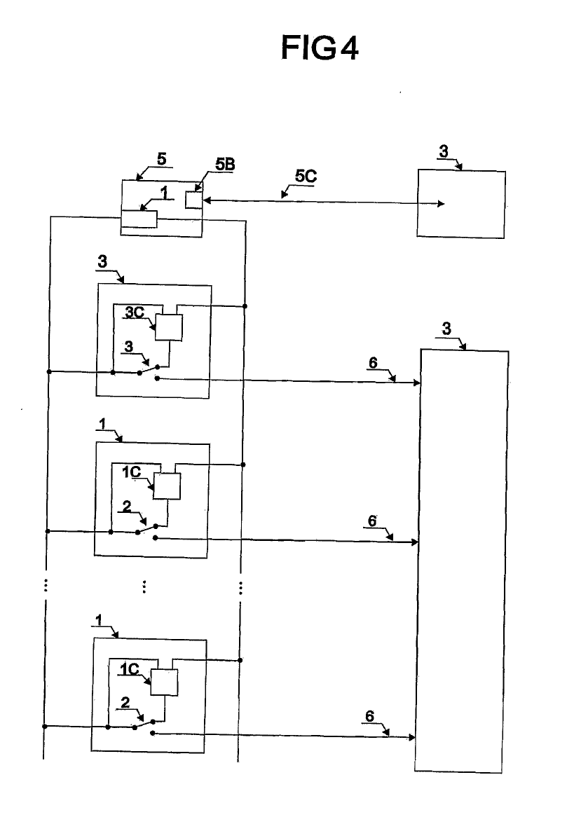

FIG. 4: Schematic of the system for acquisition of data and multiplication of signalling and protection contacts in equipments of substations and electric power plants and similar, showing application of the invention directly in the sensors and protection and supervision devices of the equipments;

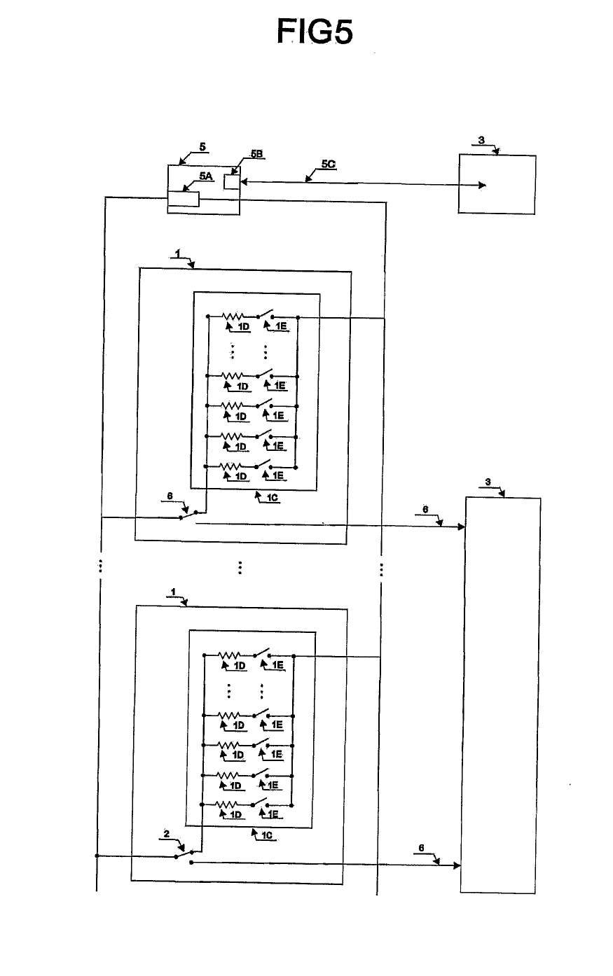

FIG. 5: Schematic of the system for acquisition of data and multiplication of signalling and protection contacts in equipments of substations and electric power plants and similar, according to application of the FIG. 4, showing technology in which the transmission of the information occurs in the form of analogical signal;

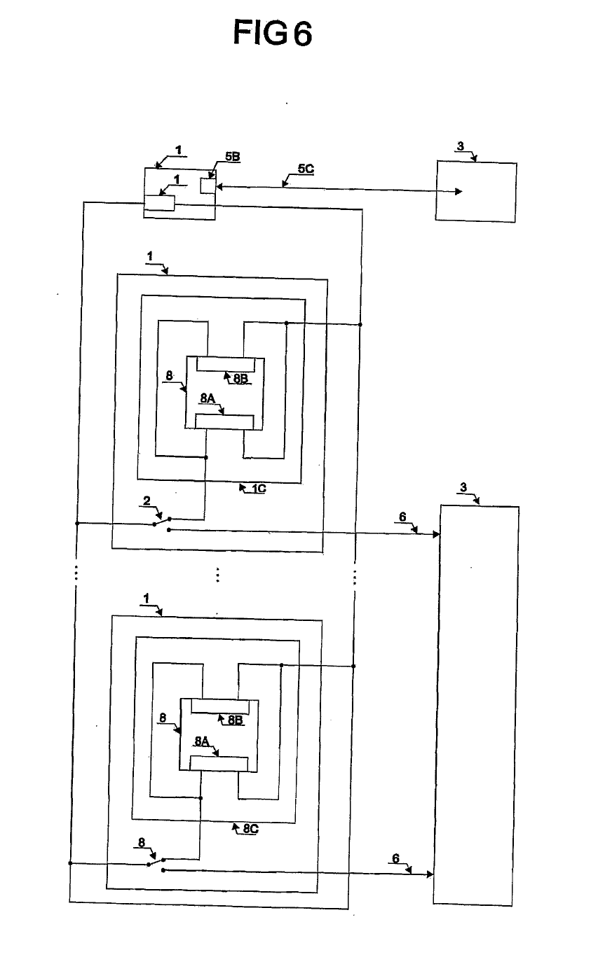

FIG. 6: Schematic of the system for acquisition of data and multiplication of signalling and protection contacts in equipments of substations and electric power plants and similar, according to application of the FIG. 4, showing technology in which the transmission of the information occurs through an electronic circuit;

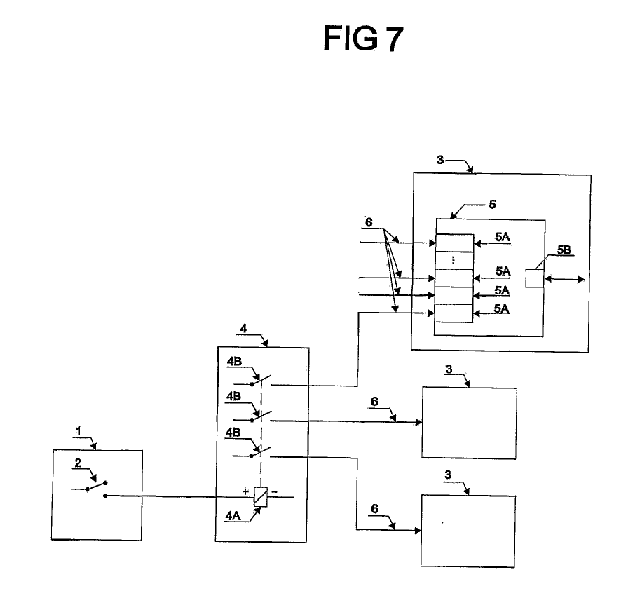

FIG. 7: Schematic of a conventional system.

The “SYSTEM FOR ACQUISITION OF DATA AND MULTIPLICATION OF SIGNALLING AND PROTECTION CONTACTS IN EQUIPMENTS OF SUBSTATIONS AND ELECTRIC POWER PLANTS AND SIMILAR”, object of this request of Patent of Invention, consists in the utilization of auxiliary relays (4) for multiplication of contacts (2) of devices (1) of protection and supervision by entrance of the information for digital acquisition of data, also making possible the digital acquisition of the state of the contacts (2) of the protection and supervision devices are accomplished directly in the devices by the incorporation of simple circuits at the same.

As it illustrates the FIG. 1, the exit contact (2) of the sensor or device (1) is connected to the bobbin (4A) of the auxiliary relay (4), bobbin that activates several exit contacts (4B) of the relay (4), staying these contacts (4B) available to transmit the information the different systems (3). The auxiliary relays (4) are of fast performance in order to not insert a substantial delay between the energizing of two bobbins (4A) and the performance of the exit contacts (4B), allowing the application with contacts for emergency disconnection equipments.

Once the information on the state of the contacts (2) are available in the auxiliary relays (4), the requested system integrates the auxiliary relays (4) to the data acquisition equipment (5) by means of an exit (4C) to two threads in the relays (4), specific for this function. Both terminals of the referred exit (4C) are connected in parallel in all auxiliary relays (4), being connected to the entrance (5A) of the data acquisition module (5), located next to the auxiliary relays (4), forming a data acquisition chain that just uses two threads.

In order to reduce the quantity of used threads, the negative side of the bobbins (4A) of the relays (4) can be used as one of the exit terminals (4C) for data acquisition, once the negative of the bobbins (4A) are interlinked in the majority of the applications. Alternatively, it can be employed as one of the exit terminals (4C) for data acquisition one of the terminals of an exit contact (4B) which in the majority of the applications is interlinked in the several relays for the connection to the positive of alimentation.

Since the information of the state of contacts (2) have arrived to the acquisition equipment (5), the same can be transmitted to the supervision systems, monitoring or another located remotely, using a door of serial communication (5B). Like a physical way (5C) for the transmission of the information, it can be used any existed pattern, as, for instance, a pair-braided, a pair of optic fibers, wireless communication or others. It is important to highlight, independent of the used physical way, that the state information of the contacts (2), before transmitted of discreet way with a thread for each contact, now are transmitted of digital form, so that physical way doesn't need to be enlarged as it increases the quantity of contacts to be monitored.

Several technologies can be used to the transmission of the state information of the contacts among auxiliary relays (4) and the acquisition equipment (5). The first of them, demonstrated in the FIG. 2, adds very low cost to the auxiliary relays (4) and it consists in the transmission of the information in the form of a coded analogical signal. For that, each auxiliary relay (4) is equipped internally with several resistors (4D). In case the contact connected to the entrance (4A) of the relay is open, the resistors (4D) will be disconnected of the exit (4C), that will be in open. If, on the contrary, the contact (2) is closed, the resistors (4D) will be connected to the exit (4C). The resistors (4D) can be inserted or left the circuit by selection contacts (4E), allowing the equivalent electric resistance obtained in the exit (4C) to reach the value wished by user. These resistors (4D) are dimensioned so that their electric resistances obey to proportionality to each other at the rate of 2⁰ to the first, 2¹ to the second, 2² to the third, 2³ to the fourth and so on. In an illustrative way, if the first resistor has resistance of 10 ohms, the second should have 20 ohms, the third 40 ohms, the fourth 80 ohms and so on.

In each auxiliary relay (4) it will be programmed a value of different resistance, without repetitions. As the exit (4C) of all relays (4) is connected in parallel, the obtained equivalent resistance in this connection is determined by closed contacts (2), so that by the continuous measurement of the referred resistance the acquisition equipment (5) is able to inform, without mistake, which contacts (2) are opened and which are closed. That is possible because the utilization of the proportionality binary among resistors (4D) of the relays (4) incapacitates that the resistance combination of two or more relays corresponds to the resistance of a third one.

A second technology possible of being maid for the transmission of the state information of the contacts among auxiliary relays (4) and the acquisition equipment (5) occurs like shown in FIG. 3, which treats more specifically of the inclusion in the relay (4) of an electronic circuit (8) provided of an entrance (8A) which makes the measurement of the contact (2) and of a door of serial communication (8B) connected to the exit of the relay (4C). The communication doors (8B) are linked in net when they are connected in parallel to the exits (4C) of all the relays (4), interlinking finally to a door of serial communication (9) in the acquisition equipment (5). Each communication door (8B) is programmed with a different address, so that the acquisition equipment (5) can communicate with each one of the relays (4), obtaining from these the information of the current state open or closed of each contact (2). Using a known serial communication pattern with resource of send of alimentation by the same communication chain, the communication door (9) of the acquisition equipment (5) is possible of provide the auxiliary alimentation to the electronic circuits (8) of the relays (4).

Countless other technologies can be equally used to the transmission of the state information of the contacts (2) among auxiliary relays (4) and the acquisition equipment (5), such as, wireless transmission by radio waves, transmission using the auxiliary alimentation cables of the installation (PLC—Power Line Communication), and others.

Besides the application above-mentioned, in which it is used the auxiliary relays (4) multipliers of contacts as a meaning of entrance of information of state of the contacts for acquisition of digital data, the same system can be applied directly to the protection and supervision sensors and devices of the equipments. Like shown in FIG. 4, in which several protection or supervision devices (1) are observed, each one with a contact of reversible exit (2) connected to a supervision or remote monitoring system (3). Largely of the applications, despite contacts (2) are reversible, it is used just the connection to the side usually open (NA) or to the usually closed side (NF), remaining one of them without utilization. Of this way, the information exit (1C) for the acquisition of data equipment (5) can be built-in the own protection device (1), using the free side NA or NF of the contacts (2).

In the last cited application, several technologies can be used to the transmission of state information of the contacts (2) among protection and supervision devices and the acquisition equipment (5), of similar way to the application, using the auxiliary relays.

The first of them shown in FIG. 5, it adds very low cost to the protection and supervision devices and consists in the transmission of the information in the form of a coded analogical signal. For that, each device (1) is equipped internally with several resistors (1D). In case the contact (2) is acted, closing the common point with the side NA of the contact, the resistors (1D) will be disconnected of the exit (1C) which will be in open. If, on the contrary, the contact (2) is in the repose, closing the common point with the side NF of the contact, the resistors (1D) will be connected to the exit (1C). The resistors (1D) can be inserted or left the circuit by means of selection contacts (1E), allowing the equivalent electric resistance obtained in the exit (1C) reaches the value wished by user. These resistors are dimensioned so that their electric resistances obey proportionality to each other at the rate of 2⁰ to the first resistor, 2¹ to the second, 2² to the third, 2³ to the fourth and so on.

In each device (1) it is programmed a value of different resistance, without repetitions. Like the exit (1C) of all the devices (1) is connected in parallel, the obtained equivalent resistance in this connection is determined by the closed contacts (2), so that by the continuous measurement of this resistance in its entrance (5A) the acquisition equipment (5) is able to inform, without mistake, which are the contacts (2) are opened and which ones are closed.

Another technology, shown in FIG. 6, can be used to the transmission of the state information of the contacts among devices (1) and the acquisition equipment (5), by means of the inclusion in the device (1) of an electronic circuit (8) provided of entrance (8A) which makes the measurement of the state of the contact (2), and of a door of serial communication (8B) which is connected to the exit (1C) of the device (1). The communication doors (8B) are connected in net to link in parallel the exits (1C) of all the devices (1), connecting finally to a door of serial communication (9) in the acquisition equipment (5). Each communication door (8B) is programmed with a distinct address, so that the acquisition equipment (5) can communicate with each one of the devices (1), obtaining of them the information of the current state open or closed of each contact (2). Using any communication pattern with resource of send of alimentation by same communication chain, the communication door (9) of the acquisition equipment (5) can provide the alimentation assist to the electronic circuits (8) of the devices (1).

Countless other technologies can be equally used to the transmission of the state information of the contacts among auxiliary relays and the acquisition equipment (5), such as, wireless transmission by radio waves, transmission using the auxiliary alimentation cables of the installation (PLC—Power Line Communication), and others.

1-31. (canceled)

32. A system for acquisition of data and multiplication of signaling and protection contacts in equipment of substations and electric power plants, characterized by integrating the functions of the auxiliary relays (4) for the multiplication of contacts and of the acquisition systems Of contact status data, making use of the fact that the information on the contact (2) statues is already available in the auxiliary relays (4).

33. The system of claim 32, wherein the outlet contact (2) of the sensor or device (1) is connected to the spool (4A) of the auxiliary relay (4), and such spool activates various outlet contacts (4B) of the relay (4), so that such contacts (4B) are available for transmitting the information to different systems (3).

34. The system of claim 33 wherein the auxiliary relay (4) is performing quickly, in such a way that a substantial delay between the energizing of its spool (4A) and the performance of the outlet contacts (4B) is not caused, thus allowing for the application with contacts for the emergency switch off of equipment.

35. The system of claim 32 wherein auxiliary relays (4) in the data acquisition equipment (5) being integrated by means of a two wire outlet (4C), specific for that function in the relays (4), whereby the two terminals of that outlet (4C) are connected in parallel in all auxiliary relays (4) aid eventually connected to the inlets (5A) of the data acquisition module (5), making up a data acquisition network that uses only two wires.

36. The system of claim 35 wherein the negative pole of the relay (4) spools (4A) is used as one of the terminals of the outlet (4C) for the data acquisition as the negative poles of the spools (4A) are already interconnected in the majority of the applications.

37. The system of claim 35 wherein one of the terminals of the outlet contact (4B) is used as one of the outlet (4C) terminals for the data acquisition.

38. The system of claim 35 wherein as soon as the contact status information (2) has reached the acquisition equipment (5) they are transmitted to the supervision, monitoring or other systems remotely located by using a serial communication port (5B), employing any existing standard as physical environment (5C) for the information transmission, such as twisted pairs, optical fiber pairs, wireless communication and others.

39. The system of claim 35 wherein the system allows for the use of several technologies for the transmission of contact status information between the auxiliary relays (4) and the acquisition equipment (5).

40. The system of claim 35 wherein the system allows for the transmission of the contact status information between the auxiliary relays (4) and the acquisition equipment (5) in the form of an encrypted analog signal.

41. The system of claim 40 wherein each auxiliary relay (4) is internally equipped with various resistors (4D) that will be disconnected from the outlet (4C) in the event the contact (2) connected to the relay inlet (4A) is open; reciprocally, in the closed contact (2), the resistors (4D) will be connected to the outlet (4C).

42. The system of claim 40 wherein the resistors (4D) being individually inserted into or taker out of the circuit by means of selection contacts (4E), thus allowing that the equivalent electrical resistance obtained in the outlet (4C) reaches the value desired by the user.

43. The system of claim 40 wherein the resistors (4D) are sized in such a way that their electrical resistances observe a binary proportional ratio amongst each other of 20 for the first resistor, 21 for the second one, 22 for the third one, 23 for the fourth one and so on.

44. The system of claim 40 wherein in each auxiliary relay (4) a different resistance value is programmed without repetitions and that the outlets (4C) of all relays (4) are connected in parallel, in such a way that the equivalent resistance obtained in such connected will be determined by the closed contacts (2).

45. The system of claim 40 wherein by the use of the binary proportionality amongst the relay (4) resistors (4D) in such a way as to make it impossible that the resistance combination of two or more relays corresponds to the resistance of a third one, thus allowing that the acquisition equipment (5) be capable of faultlessly informing which contacts (2) are open and which ones are closed by means of the continuous measuring of such resistance.

46. The system of claim 35 wherein the system allows the transmission of the contact status information between the auxiliary relays (4) and the acquisition equipment (5) by means of the inclusion, in the relay (4), of an electronic circuit (8) equipped with an inlet (8A) that carries out the measurement of the contact (2) state, equipped with a serial communication port (8B) connected to the outlet (4C) of the relay.

47. The system of claim 46 wherein the communication ports (8B) are connected in a network by connecting in parallel to the outlets (4C) of all relays (4), connecting eventually to a serial communication port (9) in the acquisition equipment (5), whereby in each communication port (8B) a different address is programmed, and such equipment (5) may communicate with each of the relays (4) and obtain from them the information about the current open or closed status of each contact (2).

48. The system of claim 46 wherein the communication port (9) of the acquisition equipment (5) provides the auxiliary feeding to the electronic circuits (8) of the relays (4) by means of the serial communication network itself, performed by a serial communication standard that is available on the market and has a feeding resource through the same communication network.

49. The system of claim 35 wherein the system allows for the transmission of the contact status information between the auxiliary relays (4) and the acquisition equipment (5) using several other technologies, such as wireless transmission by radio waves, transmission using the auxiliary feeding cables of the installation, among others.

50. The system of claim 32 wherein the system allows for the direct integration of the sensors and protection and supervision devices (1) of the equipment in the digital data acquisition, thus dispensing with the use of the auxiliary relays that multiply contacts as means of entry of contact status information.

51. The system of claim 50 wherein the information outlet (1C) to the data acquisition equipment (5) is inserted in the protection device (1) itself, using the free NO or NC side of the contacts (2).

52. The system of claim 50 wherein the system allows for the use of different technologies for the transmission of the contact (2) status information between the devices de protection and supervision (1) and the acquisition equipment (5).

53. The system of claim 50 wherein the system allows for the transmission of the contact status information (2) between the protection and supervision devices (1) and the acquisition equipment (5) in the form of an encrypted analog signal.

54. The system of claim 53 wherein each protection and supervision (1) device is internally equipped with various resistors (1D), disconnected from the outlet (1C) in the case of an activated contact (2), closing the common point with the NO side of the contact; otherwise, with the idle contact (2), when closing the common point with the NC side of the contact, the resistors (1D) will be connected to the outlet (1C).

55. The system of claim 53 wherein the resistors (1D) are individually or otherwise inserted in the circuit by means of selection contacts (1E), which allows that the equivalent electrical resistance obtained in the outlet (1C) reaches the value desired by the user.

56. The system of claim 53 wherein the resistors (1D) are sized in such a way that their electrical resistances observe a binary proportion ratio amongst each other of 2° for the first resistor, 21 for the second one, 22 for the third one, 23 for the fourth one and so on.

57. The system of claim 53 wherein each protection and supervision device (1) a different resistance value is programmed without repetitions and that the outlets (1C) of all devices (1) are connected in parallel, in such a way that an equivalent resistance obtained in that connection is determined by the contacts (2) that are closed.

58. The system of claim 53 wherein the use of binary proportionality between the device (1) resistors (1D) being in such a way as to make it impossible that the resistance combination of two or more devices (1) corresponds to the resistance of a third one, which makes it possible that the acquisition equipment (5) is capable of exactly informing which contacts (2) are open and which ones are closed by means of continuous measuring of such resistance.

59. The system of claim 50 wherein the system allows the transmission of the contact status information between the protection and supervision devices (1) and the acquisition equipment (5) by means of the inclusion, in the devices (1), of an electronic circuit (8) equipped with an inlet (8A) that carries out the measurement of the contact (2) state, whereby such circuit (8) is equipped with serial communication port (8B) connected to the outlet (1C) of the device.

60. The system of claim 59 wherein the communication ports (8B) are connected in a network by connecting in parallel to the outlets (1C) of all devices (1), eventually connecting to a serial communication port (9) in the acquisition equipment (5), whereby in each communication port (8B) a different address is programmed, in such a way that the acquisition equipment (5) may communicate with each of the devices (1) and obtain the information about the current open or closed status in each contact.

61. The system of claim 59 wherein the communication port (9) of the acquisition equipment (5) provides the auxiliary feeding for the electronic circuits (8) of the devices (1) by means of any serial communication network equipped with a feeding resource through the same communication network.

62. The system of claim 50 wherein the system allows for the transmission of the contact status information between the protection and supervision device (1) and the acquisition equipment (5) using several technologies, such as wireless transmission through radio waves, transmission using the auxiliary feeding cables of the installation, among others.
